(19) United States
(12) Patent Application Publication
(10) Pub. No.: US 2012/0121950 A1
(43) Pub. Date: May 17, 2012

(54) BATTERY MODULE

(76) Inventor: Young-Bin Lim, Yongin-si (KR)

(21) Appl. No.: 13/019,285

(22) Filed: Feb. 1, 2011

(30) Foreign Application Priority Data
Nov. 11, 2010 (KR) 10-2010-0112073

(51) Int. Cl. H01M 2/12

(52) U.S. Cl. 429/88

(57) ABSTRACT

A battery module including a first end plate and a second end plate that face each other, wherein the first and second end plate each include a protrusion; a plurality of battery cells stacked together between the first and second end plates, each of the battery cells having a vent thereon; and a degassing cover covering the vent of each of the battery cells, wherein the degassing cover includes an accommodating unit accommodating the protrusion.

### CROSS-REFERENCE TO RELATED APPLICATION

This application claims priority to and the benefit of Korean Patent Application No. 10-2010-0112073, filed on Nov. 11, 2010, in the Korean Intellectual Property Office, the entire content of which is incorporated herein by reference.

### BACKGROUND

1. Field

An embodiment of the present invention relates to a battery module including a plurality of battery cells.

2. Description of Related Art

In general, a battery cell is used as the energy source of a mobile apparatus, an electric vehicle, a hybrid vehicle, and electricity and the shape of the battery cell varies depending on the applied external apparatus.

A small mobile apparatus such as a cellular phone may be operated for a period of time with the output and capacity of a single battery. However, an electric vehicle and the hybrid vehicle with large power consumption that are driven for a long time may require a battery module including a plurality of battery cells due to increased output and capacity requirements. The battery module may increase an output voltage or an output current in accordance with the number of built in battery cells.

### SUMMARY

Accordingly, the present invention has been made to provide a battery module having fewer components so that production efficiency increases.

The present invention has also been made to provide a battery module capable of firmly fixing a plurality of battery cells.

A battery module is provided including a first end plate and a second end plate that face each other, wherein the first and second end plate each include a protrusion; a plurality of battery cells stacked together between the first and second end plates, each of the battery cells having a vent thereon; and a degassing cover covering the vent of each of the battery cells, wherein the degassing cover includes an accommodating unit accommodating the protrusion.

In one embodiment, the protrusion directly contacts the degassing cover. Further, in one embodiment, the accommodating unit includes a double wall and the protrusion is fastened to the double wall. The protrusion may be shaped to generally correspond to a space within the double wall of the accommodating unit. Further, at least one surface of the protrusion may be a roughened surface. The roughened surface may be provided on an external-facing surface of the protrusion, and the accommodating unit may also include a roughened surface on a surface facing the external-facing surface of the protrusion.

In one embodiment, an adhesive member, for example, double-sided tape, is between the protrusion and the accommodating unit. Further, in one embodiment, the battery module includes fastening units, for example, a groove-protrusion assembly or a hook assembly, in the protrusion and in the accommodating unit corresponding to the protrusion.

In one embodiment, the degassing cover contacts each of the battery cells to form a gas channel, and wherein the degassing cover has a discharge hole coupled to the gas channel. The discharge hole may be T-shaped to protrude from one side of the degassing cover and to have through holes oriented in opposing directions.

As described above, according to embodiments of the present invention, the battery module has a reduced number of components so that the battery module weight is minimized and so that the production cost of the battery module is reduced.

In addition, according to the present invention, the battery cell does not vibrate due to external shock so that the stability of the battery module may be improved.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view illustrating a battery module according to an embodiment of the present invention;

FIG. 2 is a partially exploded perspective view illustrating the battery module according to the embodiment of the present invention;

FIG. 3 is a sectional view taken along the line A-A of FIG. 1;

FIG. 4 is a partially exploded perspective view illustrating a battery module according to another embodiment of the present invention;

FIG. 5 is a view illustrating a first or second end plate and the degassing cover of FIG. 4 fastened to each other;

FIG. 6 is a partially exploded perspective view illustrating a battery module according to still another embodiment of the present invention; and

FIG. 7 is a view illustrating a first or second end plate and the degassing cover of FIG. 6 fastened to each other.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on another element or be indirectly on another element with one or more intervening elements interposed therebetween. Also, when an element is referred to as being “connected to” another element, it can be directly connected to another element or be indirectly connected to another element with one or more intervening elements interposed therebetween. Hereinafter, like reference numerals refer to like elements.

Detailed items of the other embodiments are included in detailed description and drawings.

The characteristics of the present invention and a method of achieving the characteristics of the present invention now will be described more fully with reference to the accompanying drawings, in which exemplary embodiments of the invention are shown. This invention may, however, be embodied in many different forms and should not be construed as being limited to the embodiments set forth herein. In the drawings, when a part is coupled to another part, the part may be directly coupled to another part and the part may be electrically coupled to another part with another element interposed. In the drawings, the part that is not related to the present invention is omitted for clarity of description. The same reference numerals in different drawings represent the same element, and thus their description will be omitted.

Hereinafter, the present invention will be described with reference to the accompanying drawings.

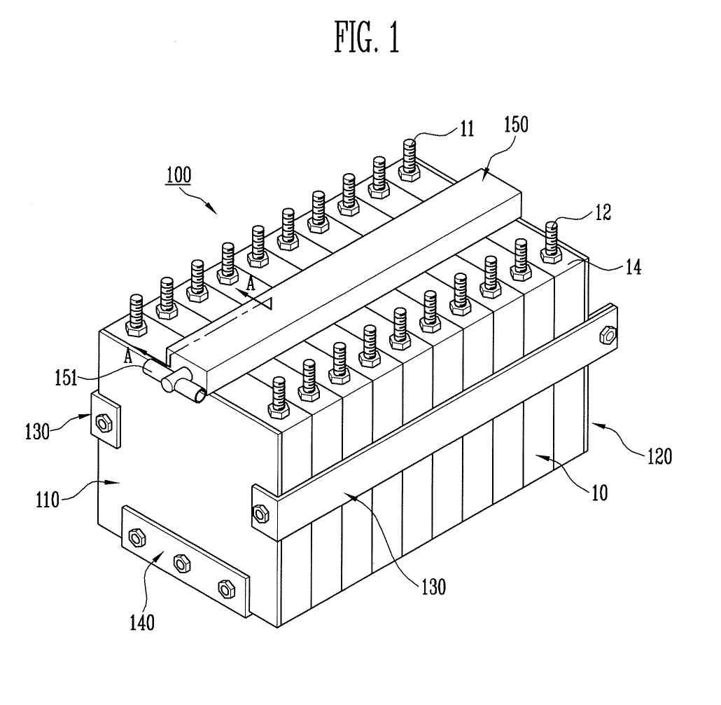

An exemplary embodiment of the present invention will be described with reference to FIGS. 1 to 3.

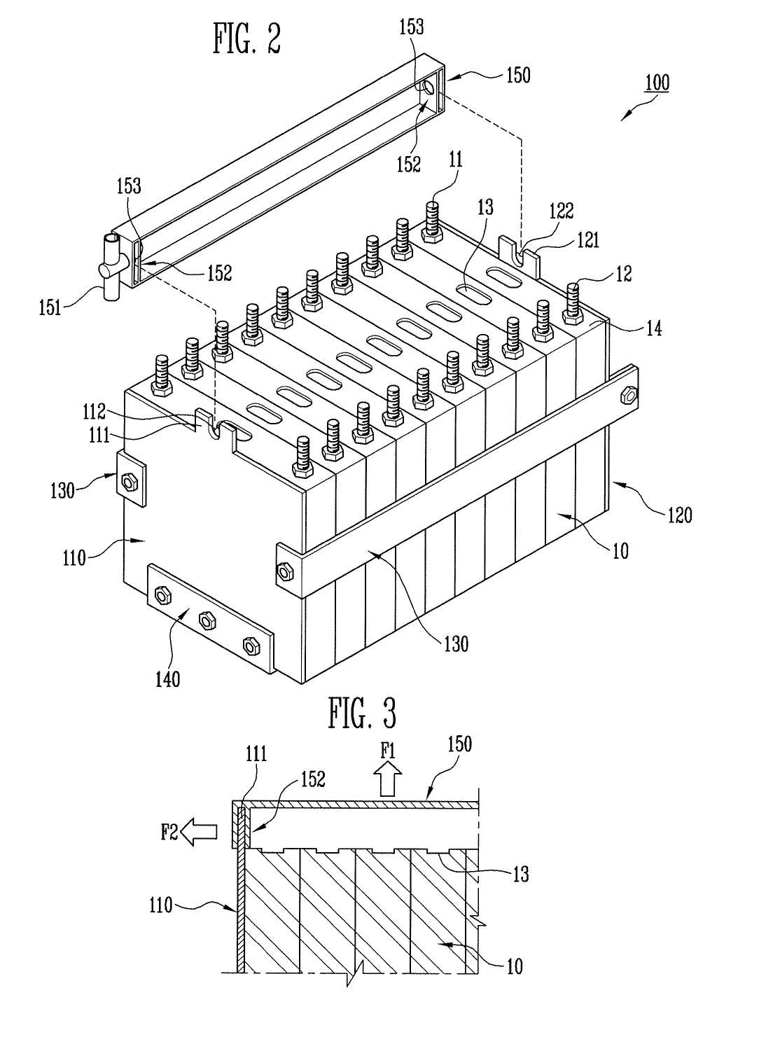

FIG. 1 is a perspective view illustrating a battery module according to an embodiment of the present invention. FIG. 2 is an exploded perspective view illustrating the battery module according to the embodiment of the present invention.

Referring to FIGS. 1 and 2, a battery module 100 according to an exemplary embodiment of the present invention may further include first and second end plates 110 and 120 arranged to face each other as a pair, a plurality of battery cells 10 stacked between the first and second end plates 110 and 120, and a degassing cover 150 for covering one side of the plurality of battery cells 10. Further, protrusions 111 and 121 are provided in the first and second end plates 110 and 120, and accommodating units 152 for accommodating the protrusions 111 and 121 are provided in the degassing cover 150. In addition, the battery module 100 may further include coupling members 130 and 140 for coupling the first and second end plates 110 and 120 to each other.

The battery cell 10 includes a battery case having an opening and a cap plate 14 for sealing the opening. An electrode assembly including a positive electrode plate, a negative electrode plate, and a separator located between the positive electrode plate and the negative electrode plate and an electrolyte may be accommodated in the battery case. In addition, a positive terminal 11 coupled to the positive electrode plate and a negative terminal 12 coupled to the negative electrode plate are provided to protrude from either end of the cap plate 14. The positive electrode plate and the negative electrode plate generate energy in reaction to the electrolyte and the energy is transmitted to the outside through the positive terminal 11 and the negative terminal 12.

In addition, a vent 13 is provided between the positive terminal 11 and the negative terminal 12 of the cap plate 14. The vent 13 functions as a path through which a gas is discharged to the outside when the pressure of the gas reaches a threshold level in the battery cell 10 to prevent the battery cell 10 from being damaged.

The battery module 100 according to the present invention may include the plurality of battery cells 10 between the first and second end plates 110 and 120 and the plurality of battery cells 10 may be stacked. In one embodiment, the battery cells 10 are arranged to run parallel with each other so that large front surfaces (i.e., planar side walls) face each other. Therefore, the vents 13 provided in the centers of the cap plates 14 of the battery cells 10 are generally linearly arranged. The positive terminals 11 and the negative terminals 12 of two adjacent battery cells 10 may be electrically coupled to each other through bus bars formed of nickel.

According to the present embodiment, the battery cell 10 is a polygonal battery as a lithium ion secondary battery. However, the present invention is not limited to the above, but rather may be applied to various types of batteries such as lithium polymer batteries and cylindrical batteries.

The battery module 100 may include a pair of first and second end plates 110 and 120 separated from each other, and coupling members such as brackets 130 for coupling the first and second end plates 110 and 120 together. One end of each of the brackets 130 is fastened to the first end plate 110 and the other end of each of the brackets 130 is fastened to the second end plate 120. In one embodiment, the first and second end plates 110 and 120 and the brackets 130 may be fastened to each other by bolts and nuts.

The brackets 130 may be side brackets for supporting both sides of each of the battery cells 10. In addition, a bottom bracket for supporting the bottom surfaces of the battery cells 10 may be further provided. The plurality of battery cells 10 are arranged between the first and second end plates 110 and 120. The battery cells 10 are fixed in place by the side brackets 130 and the bottom bracket 140 so that the battery cells 10 do not easily vibrate due to external shock.

The first and second end plates 110 and 120 are arranged to contact the large surfaces of the outermost battery cells 10 to compress the plurality of battery cells 10 together. In one embodiment, the positive terminals 11 and the negative terminals 12 of the battery cells 10 are alternately arranged to be serially coupled to each other so that the battery cells 10 may be serially coupled to each other. However, the coupling structure of the battery cells 10 and the number of battery cells 10 may vary with the design of the battery module 100.

Referring to FIG. 2, the protrusions 111 and 121 may be provided in the first and second end plates 110 and 120. The protrusions 111 and 121 may be extended from the top edges of the first and second end plates 110 and 120. In addition, the protrusions 111 and 121 may be provided in the parts of the first and second end plates 110 and 120 that contact a degassing cover 150.

The degassing cover 150 is generally rectangular having one open side. The degassing cover 150 is settled on the cap plate 14 so that the opening of the degassing cover 150 faces the plurality of battery cells 10. In one embodiment, the vent 13 included in the cap plate 14 is provided to cover at least a part of the cap plate 14. For example, the vents 13 are provided in the same location on each of the battery cells 10 and are arranged to face in one direction and are covered by the degassing cover 150. In one embodiment, although the degassing cover 150 only has to cover the vents 13, the area by which the degassing cover 150 covers the cap plates 14 of the battery cells 10 may vary (i.e., the dimensions of the degassing cover 150 may vary as desired).

In general, the battery cells 10 deteriorate each time they are charged and discharged. Inside the battery cells 10, a gas may be generated due to the sub-reaction of the electrode assembly and the electrolyte. The vents 13 are provided in the battery cells 10 so that the gas is discharged to the outside and that the battery cells 10 are prevented from being damaged. The degassing cover 150 may be provided to tightly contact the cap plates 14. The gas discharged through the vents 13 may form a gas channel between the cap plates 14 and the degassing cover 150. In addition, gaskets for improving adhesiveness and sealing may also be provided between the cap plates 14 and the degassing cover 150. In other words, the gas generated in the battery cells 10 is discharged to the outside of the battery cells 10 through the vents 130 and the discharged gas may be collected in the space partitioned off by the degassing cover 150 and the tops of the battery cells 10, and specifically, the cap plates 14.

A discharge hole 151 coupled to the gas channel to discharge the gas to the outside may be further provided on at least one side of the degassing cover 150. The gas collected in the degassing cover 150 may be channeled through the discharge hole 151 included in the degassing cover 150 to form the gas channel and thereby effectively discharged by the gas channel.

In addition, the discharge hole 151 may be T-shaped to protrude from one side of the degassing cover 150 and have through holes on either side. Therefore, the gas discharged through the discharge hole 151 may be discharged to the outside of the degassing cover 150 through the through holes that face opposing sides to run parallel with the first end plate 110. Since the gas discharged through the battery module 100 may be oriented into opposing directions to be perpendicular to the gas channel formed inside the degassing cover 150, the gas is discharged to the outside of the battery module 100 with the flux or flow of the gas being divided.

In general, in order to use the battery module 100 with high power, the plurality of battery modules 100 are electrically coupled to each other to be used as one set. In the set, the plurality of battery modules 100 may be arranged so that the end plates of the adjacent battery modules 100 face each other to be coupled to each other. In order to minimize the volume of the battery module 100, a space between the adjacent battery modules 100 is minimized. According to the present invention, the discharge hole 151 is provided to be T-shaped so that through holes are provided on opposing sides. Therefore, the gas discharged through the discharge hole 151 does not affect the adjacent battery module 100. In addition, in the drawing, the discharge hole 151 is illustrated only on one side of the degassing cover 150. However, the discharge hole 151 may also be provided on the opposite side, which may be properly changed in accordance with the design of the battery module 100.

The short sides of the degassing cover 150 that face each other on opposite ends may be provided to contact the first and second end plates 110 and 120. In other words, the protrusions 111 and 121 provided in the first and second end plates 110 and 120 may be inserted into the inside of the degassing cover 150 to surface contact the degassing cover 150. Therefore, in order to discharge the gas to the outside through the discharge hole 151, the openings 112 and 122 may be provided in the protrusions 111 and 121 to generally correspond to the discharge holes 151. In one embodiment, the openings 112 and 122 provided in the protrusions 111 and 121 may be U-shaped so that the tops of the openings 112 and 122 are open. In the drawing, the shapes of the protrusions 111 and 121 provided in the first and second end plates 110 and 120 are the same. However, they may also be different from each other. In addition, since the openings 112 and 122 provided in the protrusions 111 and 121 may be provided to correspond to the discharge holes 151 not to block the channel of the gas, the shape of the openings 112 and 122 may vary.

FIG. 3 is a sectional view taken along the line A-A of FIG. 1, which illustrates the section in which the protrusion 121 is accommodated in the accommodating unit 152 provided in the degassing cover 150. In FIG. 3, the first end plate 110 is illustrated, which is also applied to the second end plate 120.

Referring to FIGS. 2 and 3, the degassing cover 150 may include the accommodating units 152. The accommodating units 152 accommodate the protrusions 111 and 121 provided in the above-described first and second end plates 110 and 120 to fasten the degassing cover 150 to the first and second end plates 110 and 120.

The accommodating unit 152 may be provided in the region where the first and second end plates 110 and 120 contact the degassing cover 150. The accommodating unit 152 may additionally include barrier ribs therein in the form of double walls. The protrusions 111 and 121 of the first and second end plates 110 and 120 are accommodated in the spaces partitioned off by the double walls to be fastened to the spaces and therefore may have shapes generally corresponding to the spaces partitioned off by the double walls. In addition, holes 153 spaced from the discharge holes 151 may be formed in the accommodating units 152 provided as the double walls. The gas channel in the degassing cover 150 is extended through the holes 153 of the accommodating units 152 and the openings 112 and 122 provided in the protrusions 111 and 121.

In general, the battery cells 10 deteriorate each time they are discharged and recharged so that gas may be generated in the battery cells 10. When the generated gas reaches a threshold level, the internal pressure of the battery cell 10 increases, therefore increasing the volume of the battery cells. As such, the large surfaces of the battery cells 10 expand to force the first and second end plates 110 and 120 away from each other. Such a force is referred to as a swelling force and is denoted by F2 in FIG. 3.

According to embodiments of the present invention, the protrusions 111 and 121 are provided in the first and second end plates 110 and 120 and the protrusions 111 and 121 are inserted into the accommodating units 152 of the degassing covers 150. Due to the swelling force F2 that pushes the first and second end plates 110 and 120 away from each other, a frictional force is generated between the outside surfaces of the protrusions 111 and 121 and the accommodating units 152. The frictional force increases as the volumes of the battery cells 10 increase, that is, the swelling force F2 increases.

The gas that travels through the vents 13 is generated upward and gas extrusion pressure F1 operates as a force that pushes the degassing cover 150 upward. On the other hand, since the battery module 100 according to the present invention may offset the gas extrusion pressure F1 by the above-described frictional force, the degassing cover 150 is not separated from the battery module. In other words, the gas extrusion pressure F1 generated by the battery cells 10 pushes the degassing cover 150 upward. However, due to the swelling force F2, the frictional force between the accommodating units 152 of the degassing cover 150 and the protrusions 111 and 121 of the first and second end plates 110 and 120 may be increased. Therefore, the fastening force between the degassing cover 150 and the first and second end plates 110 and 120 increases so that the degassing cover 150 is not easily separated. In addition, in order to increase the frictional force between the protrusions 111 and 121 and the accommodating units 152, the protrusions 111 and 121 may tightly contact the accommodating units 152.

As described above, since the battery module 100 according to the present invention may firmly fix the degassing cover 150 to the first and second end plates 110 and 120 using the swelling force F2 and the gas extrusion pressure F1, additional members such as bolts and nuts or rivets are not required. Therefore, since a manufacturing process such as the bolt and nut work may be omitted, production cost may be reduced and the weight of the battery module 100 due to the bolts and nuts may be reduced so that the battery module 100 may be lightened.

An adhesive member may be further provided between the external surfaces of the protrusions 111 and 121 and the accommodating units 152. For example, the adhesive member may be a double-sided tape. Due to the adhesive member, coupling force between the protrusions 111 and 121 and the accommodating units 152 increases and the degassing cover 150 may be firmly fastened to the first and second end plates 110 and 120.

Since the following embodiment is similar to the embodiment illustrated in FIGS. 1 to 3 excluding the following contents, detailed contents thereof will be omitted.

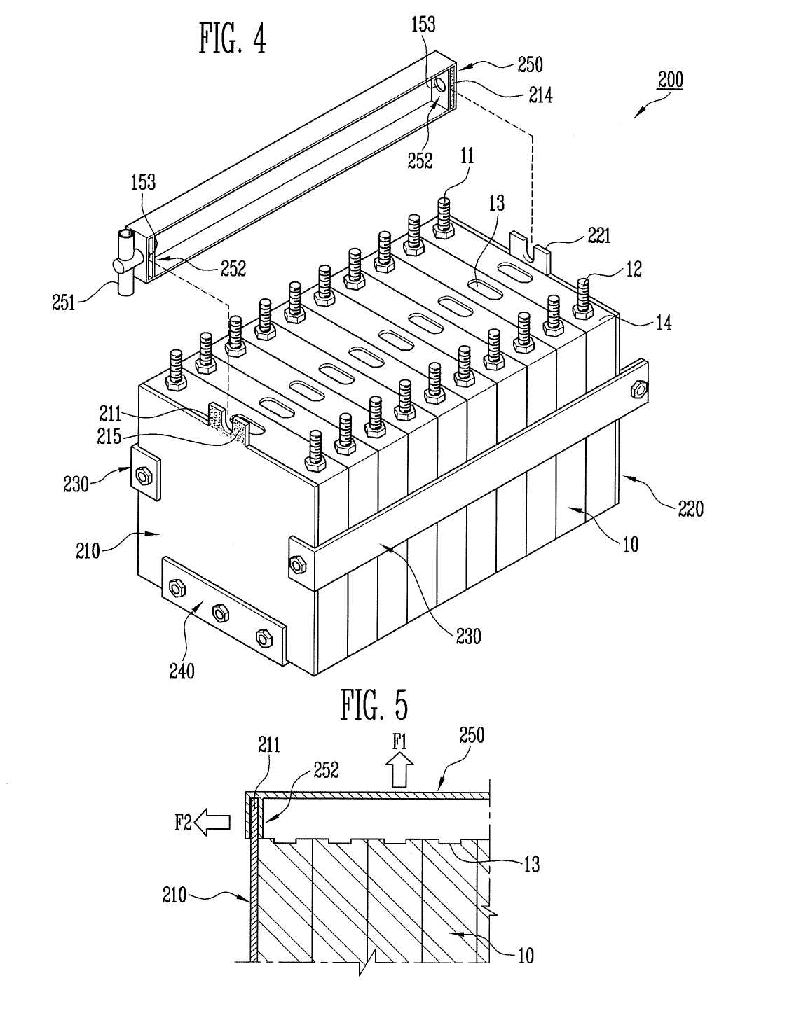

Referring to FIGS. 4 and 5, another exemplary embodiment of the present invention will be described.

FIG. 4 is an exploded perspective view of a battery module 200 according to another embodiment of the present invention. FIG. 5 is a view illustrating that the first or second end plate 210 or 220 and the degassing cover 250 of FIG. 4 are fastened to each other.

Referring to FIG. 4, the battery module 200 according to the present embodiment includes first and second end plates 210 and 220 that make a pair to face each other, the plurality of battery cells 10 arranged in one direction between the first and second end plates 210 and 220, side brackets 230 and a bottom bracket 240 for coupling the first and second end plates 210 and 220 to each other, and a degassing cover 250 for covering one side of the plurality of battery cells 10. In one embodiment, protrusions 211 and 221 are provided in the first and second end plates 210 and 220 and accommodating units 252 for accommodating the protrusions 211 and 221 are provided in the degassing cover 250. Holes 253 are provided in the accommodating units 252 to be coupled to discharge holes 251 and openings provided in the protrusions 211 and 221, which becomes a channel through which a gas is discharged.

In addition, a roughened surface 215 may be formed on at least one surface of each of the protrusions 211 and 221. The roughened surfaces 215 may be provided against the direction in which the swelling force F2 is applied in order to maximize the frictional force between the protrusions 211 and 221 and the accommodating units 252. Therefore, the roughened surfaces 215 may be provided on the external surfaces of the protrusions 211 and 221. In addition, in order to increase the frictional force, a roughened surface 214 may be further provided on the surfaces of the degassing cover 250 that face the external surfaces of the protrusions 211 and 221.

Referring to FIG. 5, due to the roughened surfaces 215 formed in the protrusions 211 and 221, the external surfaces of the protrusions 211 and 221 are textured. Therefore, the frictional force may be increased by the roughened surfaces provided in the protrusions 211 and 221 between the protrusions 211 and 221 inserted into the accommodating units 252 and the accommodating units 252.

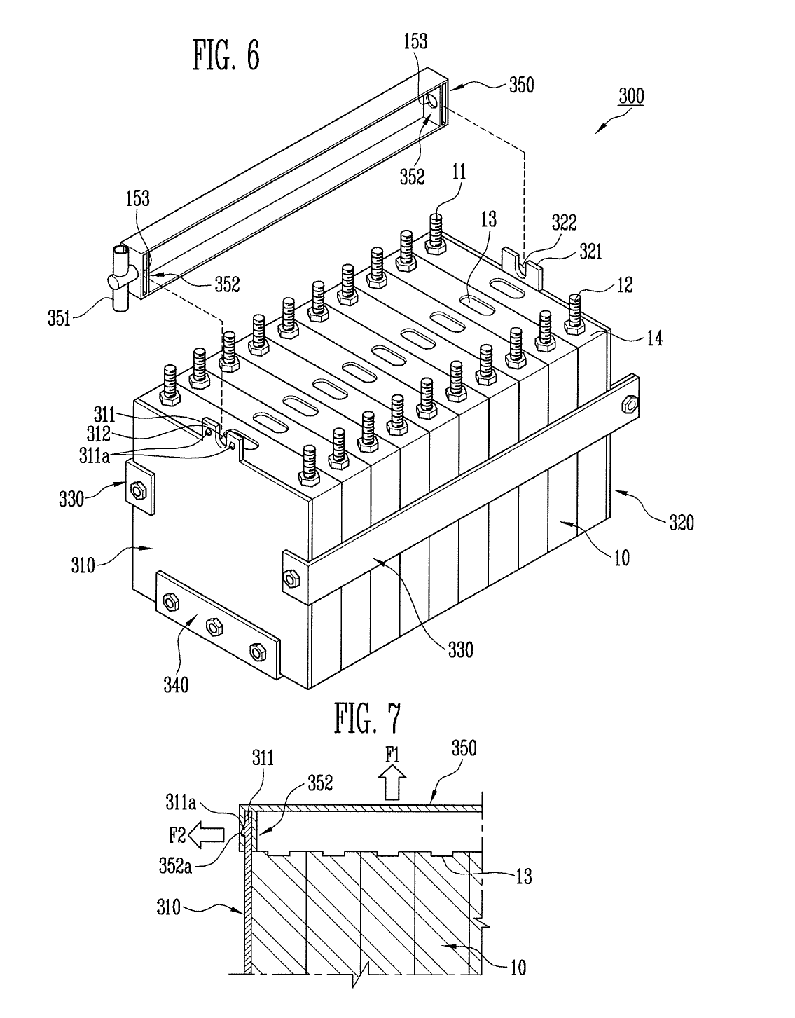

Referring to FIGS. 6 and 7, still another exemplary embodiment of the present invention will be described.

FIG. 6 is an exploded perspective view illustrating a battery module 300 according to another embodiment of the present invention. FIG. 7 is a view illustrating that the first or second end plates 310 and 320 and the degassing cover 350 of FIG. 6 are fastened to each other.

Referring to FIG. 6, the battery module 300 according to the present embodiment includes first and second end plates 310 and 320 that make a pair to face each other, a plurality of battery cells 10 stacked between the first and second end plates 310 and 320, side brackets 330 and a bottom bracket 340 for coupling the first and second end plates 310 and 320, and a degassing cover 350 for covering one side of the plurality of battery cells 10. Protrusions 311 and 321 are provided in the first and second end plates 310 and 320 and accommodating units 352 for accommodating the protrusions 311 and 321 are provided in the degassing cover 350. Holes 353 are provided in the accommodating units 352 and are extended to discharge holes 351 and openings 312 and 322 to form a channel.

In addition, fastening units 311a may be provided in the protrusions 311 and 321 and the accommodating units 352 corresponding to the protrusions 311 and 321. For example, the fastening units 311a provided in the protrusions 311 and 321 and the accommodating units 352 may be groove-protrusion coupled or hook coupled. According to the present embodiment, the fastening units 311a are groove-protrusion coupled.

Referring to FIGS. 6 and 7, two protrusions 311a are provided in the protrusions 311 and 321. In addition, grooves 352a are provided in the accommodating units 352 in the parts generally corresponding to the protrusions 321a. Therefore, when the protrusions 311 and 321 and the accommodating units 352 are fastened to each other, the protrusions 321a included in the protrusions 311 and 321 are inserted into the grooves provided in the accommodating units 352. Therefore, coupling force between the first and second end plates 310 and 320 and the degassing cover 350 may be increased.

Increased coupling force may firmly fix the degassing cover 350 to the first and second end plates 310 and 320. Therefore, when the gas extrusion pressure F1 of the battery cells 10 increases, the degassing cover 350 does not deviate from the first and second end plates 310 and 320.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. A battery module comprising:
a first end plate and a second end plate facing each other, wherein at least one of the first and second end plates comprises a protrusion;
a plurality of battery cells stacked together between the first end plate and the second end plate, each of the battery cells having a vent thereon; and
a degassing cover covering the vent of each of the battery cells, wherein the degassing cover comprises an accommodating unit accommodating the protrusion.

2. The battery module as claimed in claim 1, wherein the protrusion directly contacts the degassing cover.

3. The battery module as claimed in claim 1, wherein the accommodating unit comprises a double wall, and wherein the protrusion contacts the double wall.

4. The battery module as claimed in claim 3, wherein the protrusion is shaped to generally correspond to a space within the double wall of the accommodating unit.

5. The battery module as claimed in claim 1, wherein at least one surface of the protrusion is a roughened surface.

6. The battery module as claimed in claim 5,
wherein the roughened surface is provided on a surface of the protrusion that faces away from the battery cells, and
wherein the accommodating unit further comprises a roughened surface on a surface corresponding to the roughened surface of the protrusion.

7. The battery module as claimed in claim 1, further comprising an adhesive member between the protrusion and the accommodating unit.

8. The battery module as claimed in claim 7, wherein the adhesive member is double-sided tape.

9. The battery module as claimed in claim 1, further comprising fastening units in the protrusion and in the accommodating unit corresponding to the protrusion.

10. The battery module as claimed in claim 9, wherein the fastening unit is a groove-protrusion assembly or a hook assembly.

11. The battery module as claimed in claim 1,
wherein the degassing cover contacts each of the battery cells to form a gas channel, and
wherein the degassing cover has a discharge hole coupled to the gas channel.

12. The battery module as claimed in claim 11, wherein the discharge hole is T-shaped to protrude from one side of the degassing cover and to have through holes oriented in opposing directions.

13. The battery module as claimed in claim 11, wherein the protrusion comprises an opening generally corresponding to the discharge hole.

14. The battery module as claimed in claim 13, wherein the opening is U-shaped having an open side.

15. The battery module as claimed in claim 1, wherein the battery module further comprises coupling members coupling the first and second end plates to each other.

16. The battery module as claimed in claim 15, wherein the coupling members comprise side brackets for supporting sides of the plurality of battery cells and a bottom bracket for supporting a bottom of the battery cells
